(19) United States
(12) Patent Application Publication
(10) Pub. No.: US 2020/0132120 A1
(43) Pub. Date: Apr. 30, 2020

(54) CAGE ARRANGEMENT FOR DEEP-ROLLING ROLLERS

(71) Applicant: HEGENSCHEIDT-MFD GMBH, Erkelenz (DE)

(72) Inventors: Toni STEFFENS, Erkelenz (DE); Johannes ZIMMERMANN, Selfkant (DE); Werner KISSER, Erkelenz (DE)

(73) Assignee: Hegenscheidt-MFD GmbH, Erkelenz (DE)

(21) Appl. No.: 16/495,928

(22) PCT Filed: Mar. 22, 2018
(86) PCT No.: PCT/EP2018/057267

§ 371 Date: Sep. 20, 2019

(30) Foreign Application Priority Data
Mar. 24, 2017 (EP) 17162750.8

(51) Int. Cl. F16C 33/54; F16C 19/26

(52) U.S. Cl. CPC F16C 33/541; F16C 19/26

(57) ABSTRACT

A cage arrangement comprises substantially flat rollers, which are guided in a roller cage arranged on a housing and are held in position by a substantially strip-like cage metal sheet attached to the housing at a position remote from the roller region. The cage metal sheet has a retaining piece that protrudes in the direction of a roller in an intended installation position and has an end-face region, the shape of which corresponds to that of a roller surface facing the retaining piece.

### CROSS-REFERENCE TO RELATED APPLICATIONS

This application is a National Phase of International Application No. PCT/EP2018/057267 filed on Mar. 22, 2018. This application claims the benefit of European Patent Application No. 17162750.8, filed on Mar. 24, 2017. The entire disclosures of the above applications are incorporated herein by reference.

### FIELD

This disclosure relates to a cage arrangement for work rollers. These are essentially disc-shaped rollers which are guided in a roller cage arranged on a housing and held in position by a cage plate which is essentially strip-shaped and attached to the housing in a position which is remote from the area of the roller.

### BACKGROUND

This section provides background information related to the present disclosure which is not necessarily prior art.

Such cage arrangements are known from the state of the art.

A generic device is described in EP 0 839 607, for example. In this device, a work roller is supported against a pair of rollers and held by a gate plate.

In WO 02/22284 A1, a generic roller cage is described, in which lubricant-storing and discharging materials are used to supply lubricant to the work roller if required.

From EP 1468783 A1, a cage arrangement is known which essentially comprises disc-shaped rollers that are guided in a roller cage arranged on a housing.

In the meantime the rolling processes have become more complex, in particular through better measuring methods and control methods. Work rollers are no longer necessarily symmetrical along their central plane, but instead have contours that enable the optimum support for and dissipation of forces in order to produce the desired contours in an optimum manner and at the same time improve the service life of the rollers. Furthermore, it is desirable to be able to design the housings to be more flexible in different embodiments. It is therefore important that the work rollers are installed correctly. Otherwise, neither can the desired positions be rolled, nor are the rollers adequately supported.

### SUMMARY

This section provides a general summary of the disclosure, and is not a comprehensive disclosure of its full scope or all of its features.

On the basis of the aforementioned state of the art, the present disclosure is founded on the task of further developing a cage arrangement of the generic type so that it is more or less impossible for work rollers to be installed incorrectly and, in addition, optimum guidance and support of the rollers is provided.

For the technical solution of this task, a cage arrangement with the features of the present disclosure is proposed. Further advantages and features are explained in the subclaims.

According to the disclosure, the cage plate includes a retaining bar. This is located in the intended installation position in the direction of a roller and is provided in the front surface area in such a way that it corresponds there to the shape of the roller surface facing the bar in accordance with the designated purpose. In this way, the roller is held perfectly in position and supported. Furthermore, it is not possible to install the roller the wrong way round, as the mould covering is then no longer present.

In an advantageous manner, the cage plate can have two corresponding retaining bars, both of which are prepared or shaped in the front surface area according to the roller shapes. As a result, a pair of rollers can be arranged and held against the housing with a cage plate. It is of course possible for more than one such formations to be present if the tool is controlled accordingly.

In an advantageous way, the retaining bar is formed at the end of the cage plate. This is implemented as a rule for cage plates which are attached on one side. Otherwise, the cage plate can have retaining bars in the central area.

In an advantageous way, the cage plate is formed from one piece, i.e. the retaining bars are formed in one piece with the cage plate. It is of course also possible to include assembled and even replaceable solutions as part of the disclosure.

According to an advantageous proposal, the cage plate is made of metal, but can also be made of all other materials, as is customary in the state of the art. These include, for example, the use of materials which are suitable for absorbing and dispensing lubricants which can be used at least in the area of the retaining bars. Modular production from different materials is also possible.

In an advantageous way, the cage plate has an adjustable gate in order to optimally position and adjust it relative to the rollers which are to be held in place. According to an advantageous proposal of the disclosure, an adjusting gate can be provided in the form of an end-section deflection of the cage plate, so that adjustment is possible by means of a draw spindle, for example.

In an advantageous way, the cage plate has an adjusting gate in both end sections for adjusting and fixing this.

Further areas of applicability will become apparent from the description provided herein. The description and specific examples in this summary are intend-ed for purposes of illustration only and are not intended to limit the scope of the pre-sent disclosure.

### DRAWINGS

The drawings described herein are for illustrative purposes only of selected embodiments and not all possible implementations, and are not intended to limit the scope of the present disclosure.

With the disclosure, a solution that can be produced at low economic expense is provided which optimises the assembly and use of work rollers. Further advantages and features of the disclosure are explained in the description of the figures below:

FIG. 1 shows a schematic perspective representation of a design example for an cage arrangement,

FIG. 2 shows a top view of an embodiment of a cage plate;

FIG. 3 shows a side view of the cage plate according to FIG. 2;

FIG. 4 shows a front view of the cage plate;

FIG. 5 shows a top view of a further embodiment of a cage plate according to the disclosure.

In the above figures, identical elements are provided with the same reference characters.

Corresponding reference numerals indicate corresponding parts throughout the several views of the drawings.

### DETAILED DESCRIPTION

Example embodiments will now be described more fully with reference to the accompanying drawings.

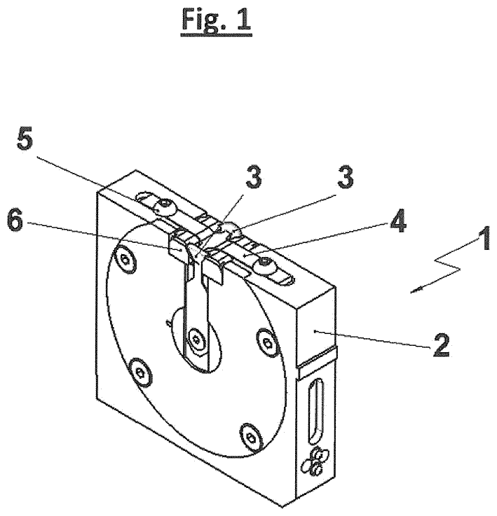

FIG. 1 shows a perspective illustration of a cage arrangement 1 with a housing 2 in which two work rollers 3 are used in the design example shown. These are located in cages 6 and are held by means of a cage plate 4, which in the design example shown is fastened to the housing 2 by means of screws 5.

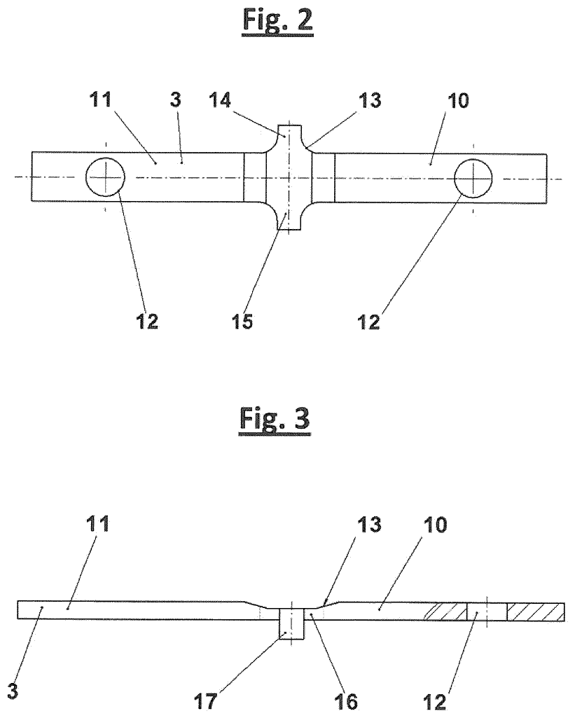

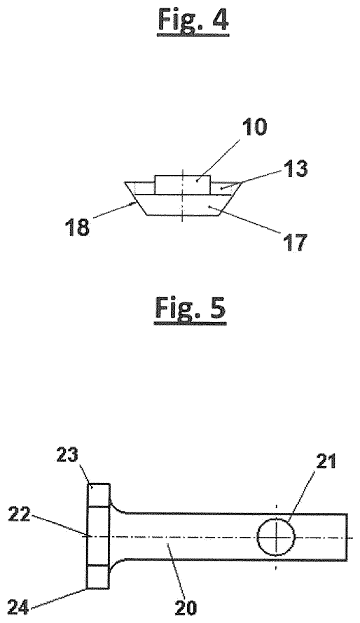

The cage plate 3 according to the disclosure is shown in detail in FIGS. 2, 3 and 4 in one embodiment. In the design example shown, cage plate 3 has two side sections 10 and 11, which include holes 12 for attachment. In the middle section 13, which in the design example shown has a depression 16, two retaining bars 14 and 15 are provided. These form part of a block of material 17, the front surfaces 18 of which are provided in the form shown. This cage plate 8 is therefore suitable for fixing rollers in place which have an approximately 70° inclination on the surface facing the cage plate, as shown in the design example.

FIG. 5 shows a variation of a cage plate 20 in which retaining bars 23, 24 are provided on the end section 22. The cage plate 20 has a borehole 21 for the attachment.

The examples described here are intended only as an explanation and are not restrictive.

The foregoing description of the embodiments has been provided for purposes of illustration and description. It is not intended to be exhaustive or to limit the disclosure. Individual elements or features of a particular embodiment are generally not limited to that particular embodiment, but, where applicable, are inter-changeable and can be used in a selected embodiment, even if not specifically shown or described. The same may also be varied in many ways. Such variations are to be regarded as a departure from the disclosure, and all such modifications are intended to be included within the scope of the disclosure.

1. A cage arrangement which essentially comprises disc-shaped rollers which are guided in a roller cage arranged on a housing and held in position by a cage plate which is essentially strip-shaped and attached to the housing in a position which is remote from the roller area, wherein the cage plate has a retaining bar which, in the intended installation position, is located in the direction of a roller and has a front surface section which corresponds in terms of the run of the mould to a roller surface which faces the retaining bar.

2. The cage arrangement according to claim 1, wherein the cage plate has two retaining bars which are both provided accordingly in the area of the front surface.

3. The cage arrangement according to claim 1, wherein the retaining bar is provided centrally on the cage plate.

4. The cage arrangement according to claim 1, wherein the retaining bar is provided on the end of the cage plate.

5. The cage arrangement according to claim 1, wherein the cage plate is provided in one piece.

6. The cage arrangement according to claim 1, wherein the cage plate is made from metal.

7. The cage arrangement according to claim 1, wherein the retaining bar is formed from a material which is suitable for receiving and dispensing lubricant.

8. The cage arrangement according to claim 1, wherein the cage plate includes an adjusting gate.

9. The cage arrangement according to claim 1, wherein the adjusting gate is formed by an end-side deflection of the cage plate.

10. The cage arrangement according to claim 1, wherein the cage plate includes an adjusting gate at both ends.
